(19) United States
(12) Patent Application Publication
(10) Pub. No.: US 2004/0238802 A1
(43) Pub. Date: Dec. 2, 2004

(54) Combustion promoting material

(76) Inventor: Tomio Inoue, Seto-shi (JP)

Correspondence Address: FLYNN THIEL BOUTELL & TANIS, P.C., 2026 RAMBLING ROAD, KALAMAZOO, MI, 49008-1699, US

(21) Appl. No.: 10/843,772

(22) Filed: May 12, 2004

(30) Foreign Application Priority Data
May 26, 2003 (JP) 2003-147445

(51) Int. Cl. C09K 11/04; C09K 3/00; G21G 4/00

(52) U.S. Cl. 252/625; 252/644

(57) ABSTRACT

Preventing incomplete combustion of fuel in a heat apparatus and equipment.

Radioactive substance 4 is fixed to a sheet-like material 3 and this sheet-like material is attached to an air supply path A or a fuel supply path F of heat apparatus or equipment. Alternatively, radioactive substance 4 is mixed in raw material resin 7 and part of the air supply path A or the fuel supply path F is formed with an obtained compound. Or radioactive substance 4 is mixed in a paint 8 and this paint is applied to the air supply path A or the fuel supply path F. Consequently, air or fuel supplied to the heat apparatus or heat equipment is excited by radioactive ray so as to intensify chemical reaction activity of air or fuel thereby promoting oxidation reaction of oxygen namely combustion and preventing incomplete combustion.

### BACKGROUND OF THE INVENTION

1. Field of the Invention

The present invention relates to a combustion promoting material used in a heat apparatus such as internal combustion engine or heat equipment such as industrial furnace in order to prevent incomplete combustion.

2. Description of Related Art

Conventionally, a heat apparatus such as automobile engine, boiler, electric generator and heat equipment such as blast furnace, kiln obtain a drive force or heat of an object by burning various kinds of fuels of solid, liquid or gas.

Combustion is a phenomenon that oxygen in the air combines with fuel to produce heat and light. A theoretical minimum quantity of air necessary for complete combustion is referred to as theoretical air quantity. A ratio between this theoretical air quantity and quantity of air used for actual combustion is refereed to as air ratio. Under ordinary combustion control, combustion is carried out in the state of 1.0 or more in terms of air ratio, that is, by supplying excessive air in order to prevent incomplete combustion.

The inventor of the present invention has not researched preceding technologies at research/development stage and patent filing stage and therefore, he has no knowledge about the preceding technologies which should be mentioned here.

Even if excessive amount of air is supplied, complete combustion cannot be realized and carbon monoxide CO and hydrocarbon HC in emission gas cannot be eliminated completely. The carbon monoxide and hydrogen carbon result in air pollution and global warming. As evident from heat balance theory, combustion with excessive air is wasting of heat energy and has been demanded to be improved from viewpoint of energy saving.

### SUMMARY OF THE INVENTION

In views of the above-mentioned problem, according to the present invention, radioactive substance is fixed to a sheet-like material and this sheet-like material is attached to an air supply path or a fuel supply path of heat apparatus or equipment. Alternatively, radioactive substance is mixed in raw material resin and part of the air supply path or the fuel supply path is formed with an obtained compound. Or radioactive substance is mixed in a paint and this paint is applied to the air supply path or the fuel supply path. Consequently, air or fuel supplied to the heat apparatus or heat equipment is excited by radioactive ray so as to intensify chemical reaction activity of air or fuel, thereby promoting oxidation reaction of oxygen namely combustion and preventing incomplete combustion. As a result, the above-described problem is solved.

### BRIEF DESCRIPTION OF DRAWINGS

FIG. 1 is a schematic longitudinal sectional view of the combustion promoting material of the present invention;

FIG. 2 is a usage state diagram of a sheet-like combustion promoting material and a combustion promoting material formed in the shape of a fuel supply path; and

FIG. 3 is a usage state diagram of a paint-like combustion promoting material.

### DESCRIPTION OF THE PREFERRED EMBODIMENTS

Hereinafter, an embodiment of the present invention will be described with reference to the accompanying drawings.

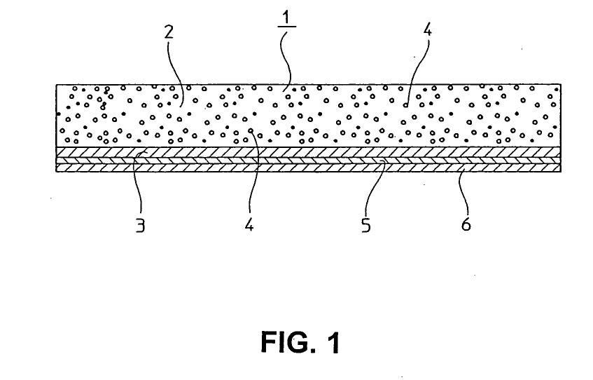

As shown in FIG. 1, a combustion promoting material 1 of the present invention is produced by fixing radioactive substance 4 on the surface of a sheet-like material 3 using adhesive agent 2 made of epoxy resin or the like.

An adhesive layer 5 is provided on the rear face and the surface of the adhesive layer 5 is covered with a separation paper 6.

Any sheet-like material 3 is permissible as long as it has plasticity and for example, metallic foil, resin film, unwoven fabric and the like are acceptable.

The radioactive substance 4 emits an ultra small amount of radioactive ray which does not affect the human body and for example, radium, radon and the like can be mentioned. The radioactive substance 4 is preferred to be of fine powder type although there is no limitation on which it is natural ore or refined product.

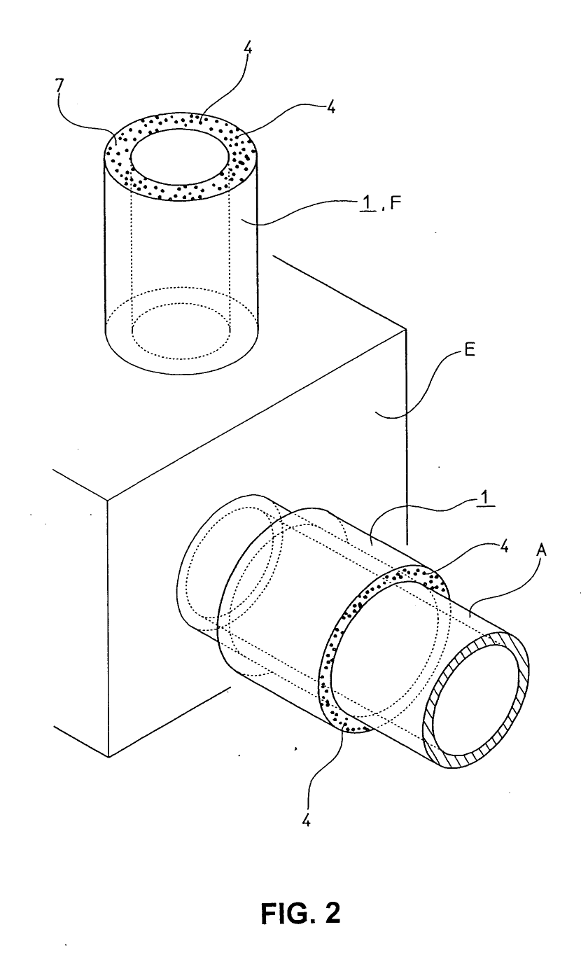

Upon use, after the separation paper 6 is removed, the adhesive layer 5 on the rear surface is pressed against an object. For example, when it is used on automobile, this sheet-like material is wound around an air supply path A such as an air suction pipe connected to a combustion chamber in an engine E, an air cleaner box connected to the engine, and air introduction pipe for introducing outside air into the air cleaner (see FIG. 2) or bonded to a fuel supply path such as a fuel tank and fuel pipe for supplying fuel in the fuel tank to the engine E (not shown).

Next, a modification example will be described.

The fuel promoting material 1 of a first modification is produced by mixing the radioactive substance 4 in raw material resin 7 and then forming an obtained compound into a desired shape. For example, that compound is formed into the shape of the above-mentioned air supply path A (not shown) or the shape of the fuel supply path F (see FIG. 2).

The raw material resin 7 may be of any type if it can be formed into an appropriate shape, and for example, thermoset resin such as phenol resin, formaldehyde resin, urea resin, silicon resin, and thermoplastic resin such as polyethylene, polystyrene, poly methyl methacrylate can be mentioned.

In the electric characteristic modifying material 1 of a second modification, the radioactive substance 4 is mixed with a paint 8. As the paint 8, any well known one may be used whether it is organic or inorganic.

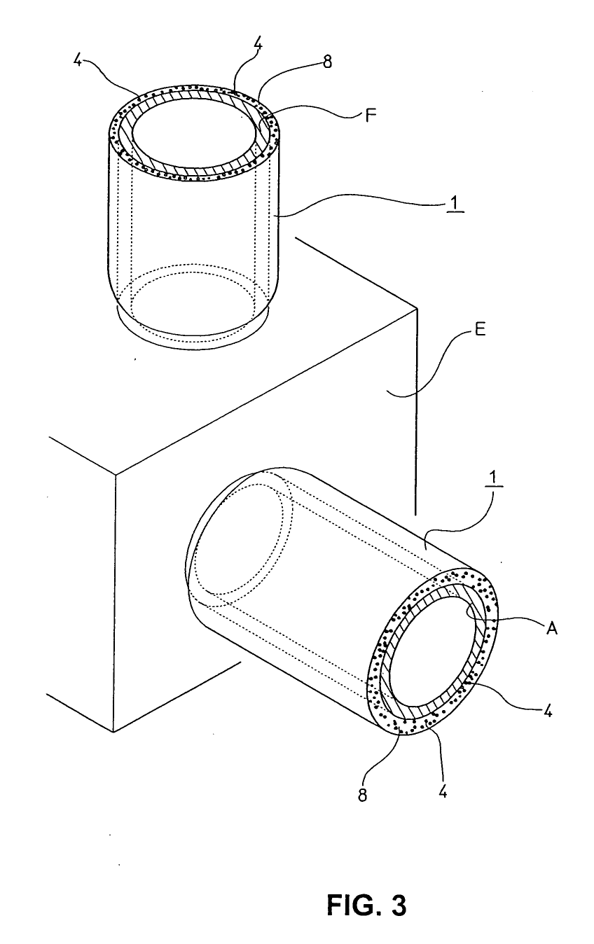

Upon use, the surfaces of the air supply path A and the fuel supply path F are coated with the same material 4 (see FIG. 3).

Next, an operation of the combustion promoting material of the present invention will be described.

The radioactive substance 4 in the combustion promoting material 1 always emits radioactive ray.

In oxygen in the air flowing through the air supply path A or fuel flowing through the fuel supply path F (for example, gasoline, petroleum gas, natural gas and the like) after receiving this radioactive ray, electrons relating to bonding of oxygen molecule and fuel molecule are transited so that oxygen or fuel is excited, thereby leading to a state in which chemical reaction is likely to occur.

Thus, even if air ratio is set to the closest possible to 1.0 by reducing the quantity of supplied air, generation of combustion residue such as carbon monoxide and hydrocarbon due to incomplete combustion hardly occurs, so that all fuel in the combustion chamber is burnt completely.

In conclusion, because the present invention is achieved by fixing the radioactive substance 4 onto the sheet-like material 3, combustion efficiency is improved only by attaching to the air supply path A or the fuel supply path F of various kinds of heat apparatus and heat equipment, so that fuel is burnt completely. Thus, harmful combustion residue such as carbon monoxide and hydrocarbon is not generated, thereby leading to purifying of emission gas and contributing to environment protection.

Further, because complete combustion of fuel can be accomplished by a smaller quantity of supplied air than before, heat energy loss can be reduced due to reduction of the quantity of emission gas thereby achieving energy saving.

Because the radioactive substance 4 is mixed in the raw material resin 7 and an obtained compound is formed, if the air suction path A connected to the automobile engine E is formed, for example, the function for improving combustion efficiency of the air suction path A itself can be provided because radioactive ray is emitted from the air suction path A. Consequently, the same effect can be obtained without taking labor and time for installing such a function later.

Because this material is produced by mixing the radioactive material 4 in the paint 8, it only has to be applied to the surface. Thus, this can be employed for existing heat apparatus and equipment, indicating that its practical effect is very large.

What is claimed is:

1. A combustion promoting material produced by fixing radioactive substance to a sheet-like material.

2. A combustion promoting material produced by mixing radioactive substance in raw material resin and forming an obtained compound.

3. A combustion promoting material produced by mixing radioactive substance in a paint.
